(19) United States
(12) Patent Application Publication
(10) Pub. No.: US 2025/0077964 A1
(43) Pub. Date: Mar. 6, 2025

(54) MODEL EVALUATION DEVICE, MODEL EVALUATION METHOD, AND PROGRAM

(71) Applicant: NEC Corporation, Minato-ku, Tokyo (JP)

(72) Inventors: Ryuta MATSUNO, Tokyo (JP); Keita SAKUMA, Tokyo (JP)

(73) Assignee: NEC Corporation, Minato-ku, Tokyo (JP)

(21) Appl. No.: 18/579,531

(22) PCT Filed: Aug. 23, 2023
(86) PCT No.: PCT/JP2023/030356

§ 371 Date: Jan. 16, 2024

(30) Foreign Application Priority Data
Jan. 26, 2023 (WO) PCT/JP2023/002444

(51) Int. Cl. G06N 20/00

(52) U.S. Cl. CPC G06N 20/00

(57) ABSTRACT

A model evaluation device 100 of the present disclosure includes a generation unit 121 that generates a plurality of second machine learning models that are different from a first machine learning model subject to performance evaluation, and an evaluation unit 122 that evaluates the first machine learning model on the basis of prediction labels that are output by inputting the same data to the first machine learning model and to each of the second machine learning models. Therefore, the model evaluation device 100 is able to assist decision making by a user.

### TECHNICAL FIELD

The present disclosure relates to a model evaluation device, a model evaluation method, and a program.

### BACKGROUND ART

Art of evaluating and managing performance of a machine learning model has been known. Patent Literature 1 discloses art of generating pseudo-correct data by giving a label to data. By the art disclosed by the patent Literature 1, a user can evaluate the performance of a machine learning model.

### CITATION LIST

### Patent Literature

Patent Literature 1: WO 2020/225923 A

### SUMMARY OF INVENTION

### Technical Problem

However, acquisition of data for evaluating the performance of a machine learning model may take time and cost. For example, in the case where data with a label cannot be acquired until a predetermined time elapses or where data with a label is generated through research and the like by professionals, it takes time and cost for acquiring data. When generating pseudo-correct data by using the art described in Patent Literature 1, it takes time and cost.

Therefore, an object of the present disclosure is to provide a model evaluation device capable of solving the above-described problem, that is, it takes time and cost for evaluating the performance of a machine learning model.

### Solution to Problem

A model evaluation device, according to one aspect of the present disclosure, is configured to include
a generation unit that generates a plurality of second machine learning models that are different from a first machine learning model subject to performance evaluation, and
an evaluation unit that evaluates the first machine learning model on the basis of prediction labels, the prediction labels being output by inputting the same data to the first machine learning model and to each of the second machine learning models.

Further, a model evaluation method, according to one aspect of the present disclosure, is configured to include
generating a plurality of second machine learning models that are different from a first machine learning model subject to performance evaluation, and
evaluating the first machine learning model on the basis of prediction labels, the prediction labels being output by inputting the same data to the first machine learning model and to each of the second machine learning models.

Further, a program, according to one aspect of the present disclosure, is configured to cause a computer to execute processing to
generate a plurality of second machine learning models that are different from a first machine learning model subject to performance evaluation, and
evaluate the first machine learning model on the basis of prediction labels, the prediction labels being output by inputting the same data to the first machine learning model and to each of the second machine learning models.

### Advantageous Effects of Invention

With the configurations described above, the present disclosure enables reduction of time and cost for evaluating the performance of a machine learning model.

### BRIEF DESCRIPTION OF DRAWINGS

FIG. 1 is a block diagram illustrating a configuration of a model evaluation device according to a first example embodiment of the present disclosure.

FIG. 2 illustrates a state of processing by the model evaluation device disclosed in FIG. 1.

FIG. 3 illustrates a state of processing by the model evaluation device disclosed in FIG. 1.

FIG. 4 illustrates a state of processing by the model evaluation device disclosed in FIG. 1.

FIG. 5 illustrates a state of processing by the model evaluation device disclosed in FIG. 1.

FIG. 6 illustrates a state of processing by the model evaluation device disclosed in FIG. 1.

FIG. 7 illustrates a state of processing by the model evaluation device disclosed in FIG. 1.

FIG. 8 is a flowchart illustrating an operation of the model evaluation device disclosed in FIG. 1.

FIG. 9 is a block diagram illustrating a hardware configuration of a model evaluation device according to a second example embodiment of the present disclosure.

FIG. 10 is a block diagram illustrating a configuration of the model evaluation device according to the second example embodiment of the present disclosure.

### DESCRIPTION OF EMBODIMENTS

### First Example Embodiment

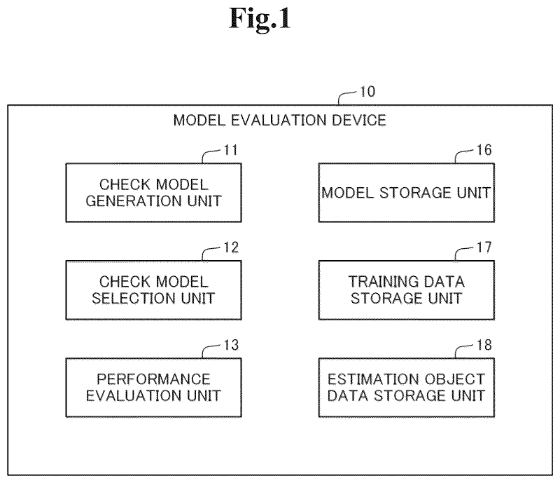

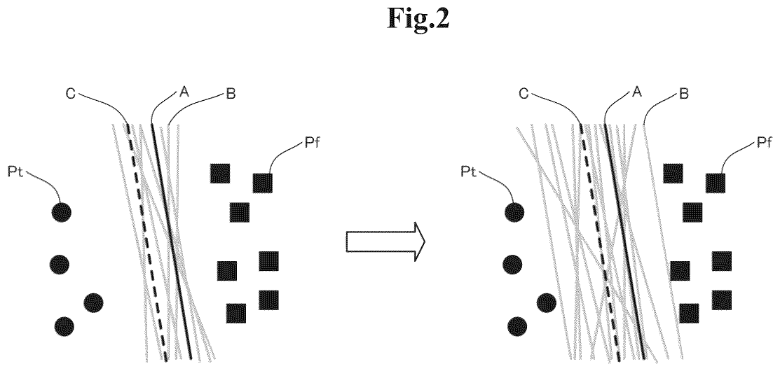

A first example embodiment of the present disclosure will be described with reference to FIGS. 1 to 8. FIG. 1 is a diagram for explaining a configuration of a model evaluation device, and FIGS. 2 to 8 are diagrams for explaining processing operation by the model evaluation device.

### [Configuration]

A model evaluation device 10 of the present embodiment is used for evaluating the prediction performance of an operation model that predicts a correct label from previously generated input data. In the case of evaluating the prediction performance, if data with a correct label corresponding to input data is used, it may take time and cost to acquire such data. Therefore, the model evaluation device of the present embodiment performs evaluation by using input data to which a correct label is not given.

The model evaluation device 10 of the present embodiment is configured of one or a plurality of information processing devices each having an arithmetic device and a storage device. As illustrated in FIG. 1, the model evaluation device 10 includes a check model generation unit 11, a check model selection unit 12, and a performance evaluation unit 13. The functions of the check model generation unit 11, the check model selection unit 12, and the performance evaluation unit 13 can be realized through execution, by the arithmetic device, of a program for realizing the respective functions stored in the storage device. The model evaluation device 10 also includes a model storage unit 16, a training data storage unit 17, and an estimation object data storage unit 18. The model storage unit 16, the training data storage unit 17, and the estimation object data storage unit 18 are configured of storage devices. Hereinafter, the respective constituent elements will be described in detail.

The model storage unit 16 stores therein an operation model (also referred to as a “first machine learning model”) generated by executing a machine learning algorithm using training data prepared in advance. The operation model is a model used by a predetermined estimation system, and is an object for evaluating a prediction performance.

Here, a model will be described. A model is information representing a relationship between an explanatory variable and an objective variable. A model is, for example, a component for estimating a result of a an estimation object by calculating an objective variable on the basis of an explanatory variable. A prediction model is generated by executing a machine learning algorithm with use of training data in which a value of an objective variable (also referred to as a “label”) has been acquired and arbitrary parameters as inputs. A prediction model may be expressed as a function “c” for mapping an input “x” to a correct answer “y”.

Note that a prediction model may be referred to as a “learning model”, an “analysis model”, an “AI model”, a “learned model”, an “inference model”, a “prediction system”, or the like.

An explanatory variable is a variable used as an input in a prediction model. An explanatory variable may be referred to as a “feature value”, a “feature”, or the like.

A machine learning algorithm for generating a model is not limited particularly. A known learning algorithm may be used. For example, a learning algorithm may be random forest, support vector machine, naive Bayes, a neural network, a segment linear model using factorized asymptotic Bayesian (FAB) inference, or a neural network.

A method of a segment linear model using FAB inference is disclosed in, for example, US 2014/0222741 A1.

The training data storage unit 17 stores therein training data in which a label has been given to input data as described above. The training data may be used for generating the operation model, or may be used for generating a check model as described below. Moreover, besides the data used for generating the operation model, data to be used for generating a check model may be provided as training data.

The estimation object data storage unit 18 stores therein estimation object data in which a label is not given to the input data. That is, estimation object data is only input data and, as described below, it is data to be input to an operation model and a check model for evaluating the operation model, to estimate a prediction label. For example, estimation object data may be data measured from a prediction system in which the operation model is provided, or data suitable for prediction in the operation model or a check model.

The check model generation unit 11 (generation unit) executes a machine learning algorithm by using training data in which a label is given to the input data stored in the training data storage unit 17 to thereby generate a check model (also referred to as a “second machine learning model”) that outputs a label in response to an input of the input data. At that time, the check model generation unit 11 learns the training data a plurality of times, and generates a plurality of check models that are are different from each other and different from the operation model stored in the model storage unit 16. Particularly, the check model generation unit 11 generates check models so as to make them diverse, that is, so as to be dissimilar to each other. As an example, the check model generation unit 11 performs learning a plurality of times by changing the random number seed used for machine learning, and generates a plurality of check models. For example, the check model generation unit 11 learns training data by randomly reproducing and extracting it and randomly changing the hyper parameters, to generate a plurality of diverse check models that are dissimilar to each other. Note that the check model generation unit 11 may generate check models that are different from each other by any method. For example, the check model generation unit 11 may generate a plurality of check models through learning by giving a pseudo label to estimation object data to which a label is not given, or by changing the weight of the data at that time.

FIG. 2 illustrates a conceptual diagram of an operation model A (black solid line) and a check model B (gray solid line). In FIG. 2, a reference sign C denotes a true model (black dotted line), each circle mark denoted by a reference sign Pt represents training data to which a positive example label is given, and each square mark denoted by the reference sign Pf represents training data to which a negative example label is given. This example shows a conceptual diagram of the case of classifying binary labels of positive example and negative example. For example, in the case of generating a plurality of check models B without considering the diversity, there is a possibility that a plurality of check models B that are in a dense state as illustrated in the left diagram of FIG. 2 and are similar to each other are generated. On the other hand, in the case of generating a plurality of check models B through a number of times of learning by changing the random number seed as illustrated in the present embodiment, it is possible to generate check models B that are dispersed as illustrated in the right diagram of FIG. 2, are dissimilar to each other, and have diversity.

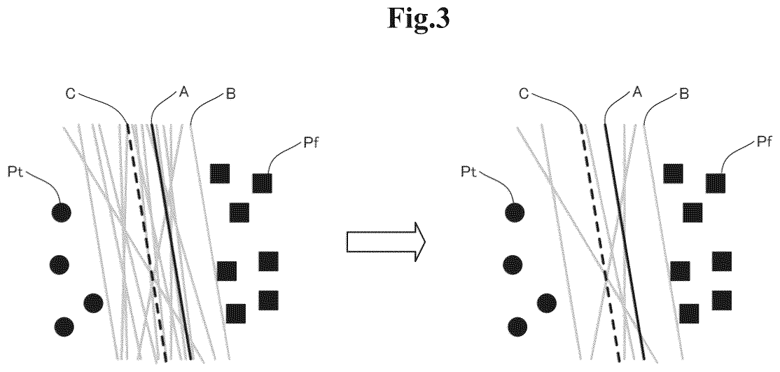

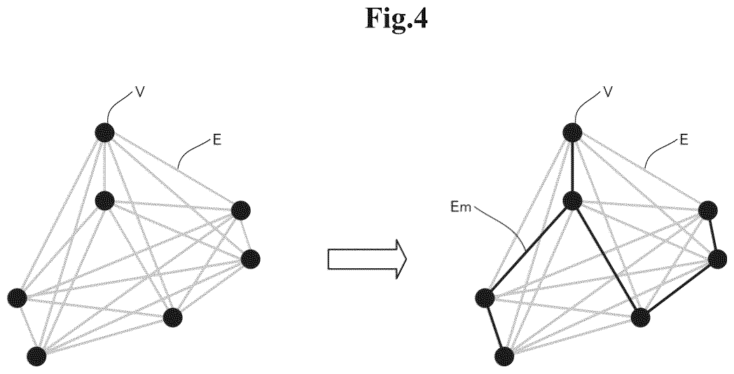

The check model selection unit 12 (selection unit) deletes some check models from the check models B generated as described above, and selects the predetermines number (for example, M pieces) of check models B that is smaller in number than the first number (for example, T pieces). At that time, the check model selection unit 12 selects check models on the basis of dissimilarity, based on a preset criteria, of prediction labels output by the check models between the respective check models B. In particular, the check model selection unit 12 selects check models such that the dissimilarity between the predetermined number of check models to be selected becomes higher. That is, as illustrated from the left drawing to the right drawing in the conceptual diagram of FIG. 3, the check model selection unit 12 deletes check models B that are similar to each other so as to thin out from a state where the check models B are in a dense state, and selects the predetermined number of check models so that the distance between the predetermined number of remaining check models becomes larger. A specific processing method to select check models will be described below with reference to FIGS. 4 to 7.

First, a plurality of check models are expressed as (g₁, g₂, . . . , g_{T}), and as an index for evaluating their diversity, a diversity reference as illustrated in Expression 1 is set.

$$Diversity Reference = {\sum }_{( i , j ) ∈ M S T ( G )} G ( i , j ) \qquad [ Expression 1 ]$$

$$G ( i , j ) = \sqrt{\frac{1}{\vert Y \vert \vert x \vert} {\sum }_{x ∈ X} {\sum }_{y ∈ Y} \vert {g}_{i} ( y \vert x ) - {g}_{j} ( y \vert x ) \vert}$$

Here, a term in Expression 1, shown as Expression 2 provided below, indicates a probability of estimating a label y with respect to input data x in the i^{th} check model. Note that X represents a set of input data x generated by adding random noise to the training data and estimation object data, or the like. Moreover, y represents a set of the whole or part of the labels.

gᵢ(y|x) [Expression 2]

Further, a term G(i,j) in Expression 1, shown as Expression 3 provided below, indicates a weighted adjacent matrix of an undirected complete graph representing the distance between a node i and a node j when each check model is expressed as a node.

G∈ [symbol] ^{M×M} [Expression 3]

FIG. 4 illustrates a graph G in which each check model is represented as a node (reference sign V), and the dissimilarity between the respective check models is represented as a weight (length) of a side (reference sign E) linking the nodes. This example shows the case where the number of nodes V corresponding to the check models is seven. The graph G shows that as the length of the side E between the nodes V is longer, that is, as the distance between the linked nodes V is farther, the dissimilarity between the check models corresponding to the respective nodes V is higher. In other words, as the length of the side E between the nodes V is shorter, that is, as the distance between the linked nodes V is closer, the check models corresponding to the respective nodes V are more similar. The left drawing of FIG. 4 illustrates the whole view of the undirected complete weighted graph G, and in the right drawing of FIG. 4, sides Em in black lines represent a minimum spanning tree that is a tree in which the length (weight) of the side E of the spanning tree configured of subtrees including all nodes V in the graph G is minimum.

It is assumed that MST(G) in Expression 1 is a function that returns a side included in the minimum spanning tree of the graph G illustrated in the right drawing of FIG. 4. Therefore, the diversity reference represented by Expression 1 becomes the total sum of the weights (lengths) of the sides of the minimum spanning tree in the graph G, and as the value is larger, the dissimilarity between the check models corresponding to the respective nodes is higher. By using it, the check model selection unit 12 selects the predetermined number of check models by deleting some check models so that the value of the diversity reference of the graph G by the predetermined number of selected check models to be larger. Here, an example of selecting four check models, among the check models corresponding to the seven nodes B in the graph G, will be described.

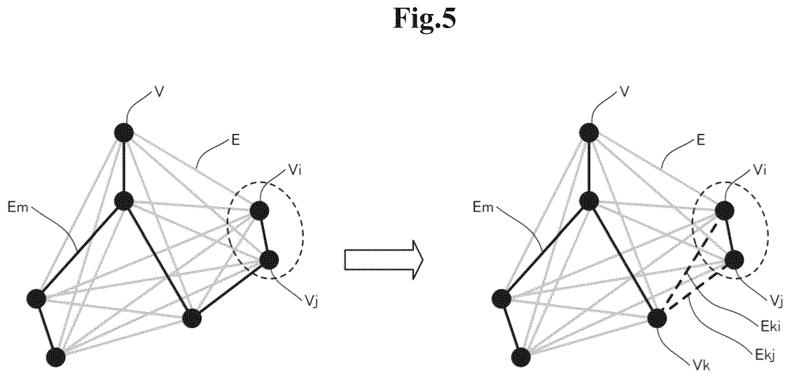

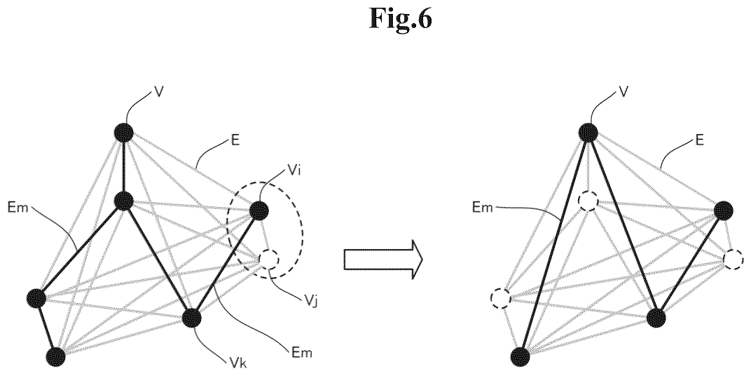

First, the check model selection unit 12 extracts two check models in which the dissimilarity between them is lower than the others. For example, the check model selection unit 12 extracts two nodes Vi and Vj linked to the shortest side Em in the graph G, as illustrated in the dotted line in the left drawing of FIG. 5. Then, by deleting one of the two nodes Vi and Vj, the check model selection unit 12 selects a check model corresponding to the remaining node. At that time, since the two nodes having the short side Em in the graph G have high similarity, by deleting one of them, it is possible to increase the diversity in the remaining check model. For example, as shown by sides in dotted lines in the right drawing of FIG. 5, the check model selection unit 12 checks the lengths (weights) of sides Eki and Ekj from another node Vk with respect to the extracted two nodes Vi and Vk, that is, the node having the shortest distance from the two nodes Vi and Vk, deletes a node linked to a shorter side, and selects the remaining node. In the example of the right drawing of FIG. 5, the node Vj, of the extracted two nodes Vi and Vj, is deleted and the node Vi is selected. Then, as illustrated in the left drawing of FIG. 6, in the graph G in a state where the node Vj is deleted and the node Vi is selected, the side Em is reconstructed so as to form the minimum spanning tree.

The check model selection unit 12 repeats the processing to extract two nodes, delete one of them, and select the other as described above, until the predetermined number of nodes are selected. As a result, as illustrated in the right drawing of FIG. 6, four nodes V among the seven nodes in the graph G are selected, and a minimum spanning tree formed of the four nodes is generated. At that time, the value of the diversity reference by the minimum spanning tree formed of the four nodes can be improved and, for example, can be maximized approximately. Then, the check model selection unit 12 selects four check models corresponding to the selected four nodes respectively, and store the selected check models in the model storage unit 16.

Note that the method of selecting check models by the check model selection unit 12 is not limited to the method described above. The check model selection unit 12 may select the predetermined number of check models from the check models generated by the check model generation unit 11 by using another diversity index. For example, as a diversity index, Q statistical amount (similarity index, diversity is lower as the Q is higher) may be used. As an example, the check model selection unit 12 may select the predetermined number of check models so as to have diversity by evaluating similarity from the matching degree in the tendency of correct and incorrect of the two check models, and deleting one of the similar check models.

The performance evaluation unit 13 (evaluation unit) reads the operation model stored in the model storage unit 16 and the selected check models and the estimation object data stored in the estimation object data storage unit 18, and evaluates the prediction performance of the operation model by using them. Specifically, the performance evaluation unit 13 inputs estimation object data to which a label is not given, into the operation model and each of the selected check models, and acquires a prediction label that is an output of each of them. Then, on the basis of a matching degree between the prediction label output from the operation model and the prediction label output from each check model, the performance evaluation unit 13 evaluates the prediction performance of the operation model. At that time, the performance evaluation unit 13 handles the prediction label of each check model as a correct label, and from the matching degree of the prediction level output from the operation model with respect to the correct label, evaluates the prediction performance of the operation model. For example, the performance evaluation unit 13 evaluates that the prediction performance of the operation model is higher as the number of check models matching the prediction labels output from the operation model is larger.

Here, a specific performance evaluation method by the performance evaluation unit 13 will be described. For example, it is assumed that a performance index is calculated according to Expression 4 provided below. It is assumed that N represents the number of pieces of estimation object data to be input.

P(f,{(xᵢ,yᵢ)}}ᵢ₌₁^{N}) [Expression 4]

Then, with use of a prediction label of each check model as a correct label, an evaluation estimation value is calculated by Expression 5 provided below. At that time, as shown by Expression 6, a weight may be applied to the evaluation with respect to each check model according to a likelihood Lⱼ of the check model.

$$Evaluation Estimation Value = \frac{1}{M} {\sum }_{j} P ( f , {\{ ( {x}_{i} , {g}_{i} ( {x}_{i} ) ) \}}_{i = 1}^{N} ) \qquad [ Expression 5 ]$$

$$Evaluation Estimation Value = {\sum }_{j} {w}_{j} P ( f , {\{ ( {x}_{i} , {g}_{i} ( {x}_{i} ) ) \}}_{i = 1}^{N} ) , {w}_{j} = \frac{{L}_{j}}{{\sum }_{k} {L}_{k}} \qquad [ Expression 6 ]$$

Note that a performance index may be one representing the accuracy of matching between the prediction label of the operation model and the prediction label of the check model as shown by Expression 7 provided below, or may be precision, recall, or an F1 value as shown by Expression 8 provided below. However, the performance index is not limited to these values, and other values may be used.

$$P ( f , {\{ ( {x}_{i} , {y}_{i} ) \}}_{i = 1}^{N} ) = \frac{1}{N} {\sum }_{i} 𝕀 [ f ( {x}_{i} ) = {y}_{i} ] \qquad [ Expression 7 ]$$

$$TP ( True Positive ) : P ( f , {\{ ( {x}_{i} , {y}_{i} ) \}}_{i = 1}^{N} ) = {\sum }_{i} 𝕀 [ f ( {x}_{i} ) = 1 ∧ {y}_{i} = 1 ] \qquad [ Expression 8 ]$$

$$FP ( False Positive ) : P ( f , {\{ ( {x}_{i} , {y}_{i} ) \}}_{i = 1}^{N} ) = {\sum }_{i} 𝕀 [ f ( {x}_{i} ) = 1 ∧ {y}_{i} = 0 ]$$

$$NP ( False Negative ) : P ( f , {\{ ( {x}_{i} , {y}_{i} ) \}}_{i = 1}^{N} ) = {\sum }_{i} 𝕀 [ f ( {x}_{i} ) = 0 ∧ {y}_{i} = 1 ]$$

$$Precision : \frac{TP}{TP + FP}$$

$$Recall : \frac{TP}{TP + FN}$$

$$F 1 Value : \frac{2 \times Precision \times Recall}{Prec i s i o n + R e c a l l}$$

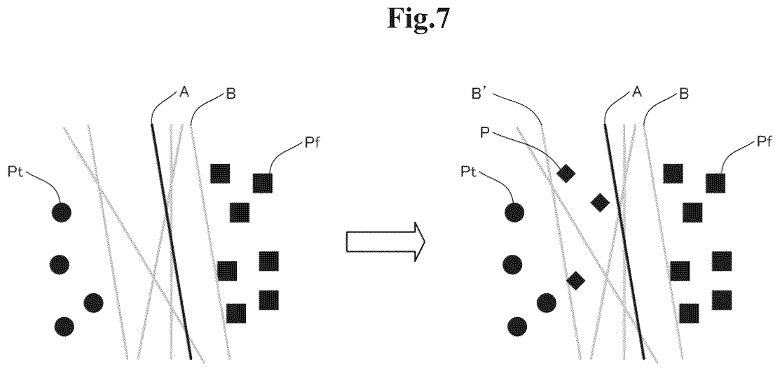

Here, a relationship between the operation model and each check model, when evaluating the operation model described above, will be described by illustrating it in FIG. 7. The left drawing of FIG. 7 illustrates a conceptual diagram of a similarity relationship between the operation model A and each check model B, indicating that as the distance is closer, the behavior of prediction is similar. In the left drawing of FIG. 7, the reference sign Pt denotes training data to which a positive example label is given, and the reference sign Pf denotes training data to which a negative example label is given. This example shows a conceptual diagram of the case of classifying binary labels of positive examples and negative examples. Further, in the right drawing of FIG. 7, a reference sign P denotes estimation object data. As illustrated in this drawing, the estimation object data P does not always have the same prediction result, that is, the same prediction label, in all of the operation model A and the respective check models B. For example, the check model denoted by the reference sign B has the same prediction result as that of the operation model A, but a check model denoted by a reference sign B′ has a different prediction result from that of the operation model A. At that time, since the estimation object data P in which the output results are different between the operation model and the check model is considered as data that is difficult to be predicted, the prediction in the operation model is regarded as wrong.

In view of the situation as described above, in a conceptual diagram as illustrated in FIG. 7, when a plurality of check models are in a dense state and the behavior of prediction becomes similar, an inappropriateness such as evaluation of the operation model being biased may occur. In order to cope with such a problem, the present embodiment generates a plurality of check models diversely and further selects some of them. Therefore, it is possible to suppress inappropriateness such as evaluation of the operation model being biased. As a result, it is possible to evaluate the operation model by using estimation object data with no label that is easily available, and to appropriately evaluate the operation model promptly at a low cost.

### [Operation]

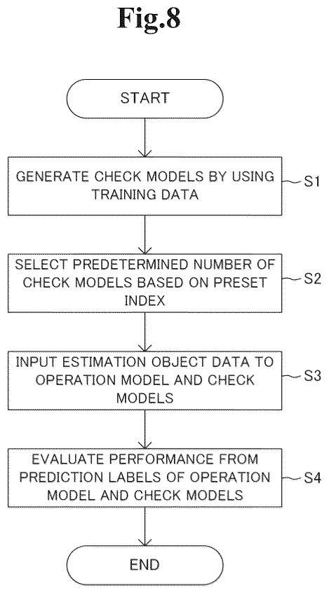

Next, operation of the model evaluation device 10 described above will be described with reference to the flowchart of FIG. 8. It is assumed that the model evaluation device 10 stores therein an operation model subject to evaluation as described above, training data used for generating the operation model, and estimation object data to be used for evaluating the operation model.

First, the model evaluation device 10 execute a machine learning algorithm by using training data to which a correct label is given, to generate a plurality of check models (step S1). At that time, the model evaluation device 10 learns the training data by randomly reproducing and extracting it and randomly changing the hyper parameters, to generate a plurality of diverse check models that are dissimilar to each other.

Then, the model evaluation device 10 selects the predetermined number of check models from the generated check models (step S2). At that time, the model evaluation device 10 selects check models on the basis of dissimilarity based on a preset reference of a prediction label output by the check models between the respective check models. In particular, the model evaluation device 10 selects check models such that the dissimilarity between the predetermined number of check models to be selected becomes higher. As an example, as described with reference to FIGS. 4 to 6, the model evaluation device 10 selects check models corresponding to nodes by using a minimum spanning tree of the graph G in which respective check models are represented as nodes (reference sign V) and the dissimilarity between the check models is represented as a weight of a side (reference sign E) connecting the nodes.

Then, the model evaluation device 10 inputs estimation object data to which a label is not given, to the operation model and each selected check model, and acquires a prediction label that is an output of each of them (step S3). Then, on the basis of a matching degree between the prediction label output from the operation model and the prediction label output from each check model, the model evaluation device 10 evaluates the prediction performance of the operation model (step S4). For example, the model evaluation device 10 handles the prediction label of each check model as a correct label, and from the matching degree of the prediction level output from the operation model with respect to the correct label, evaluates the prediction accuracy of the operation model.

As described above, the model evaluation device 10 of the present embodiment generates a plurality of check models diversely and further, selects check models, and evaluates the prediction performance of the operation model by using such check models. Therefore, it is possible to suppress inappropriateness such as evaluation of the operation model being biased because of similar check models being in a dense state. As a result, it is possible to evaluate the operation model by using estimation object data with no label that is easily available, and to appropriately evaluate the operation model promptly at a low cost.

### Application Example

Here, as an application example of the present disclosure described above, an example of applying it to the medical and healthcare field will be described. In this example, an operation model (first machine learning model) is used as a model for classifying input X-ray chest images into a sound state (positive example) and a disease state (negative example), and the prediction performance is evaluated by the model evaluation device 10. By applying such an operation model to the present disclosure, it is possible to evaluate the operation model by using X-ray chest images with no label, and to appropriately evaluate the operation model promptly at a low cost. In addition, by using the model evaluation device 10 of the present disclosure, it is possible to effectively assist decision making by the doctors.

### Second Example Embodiment

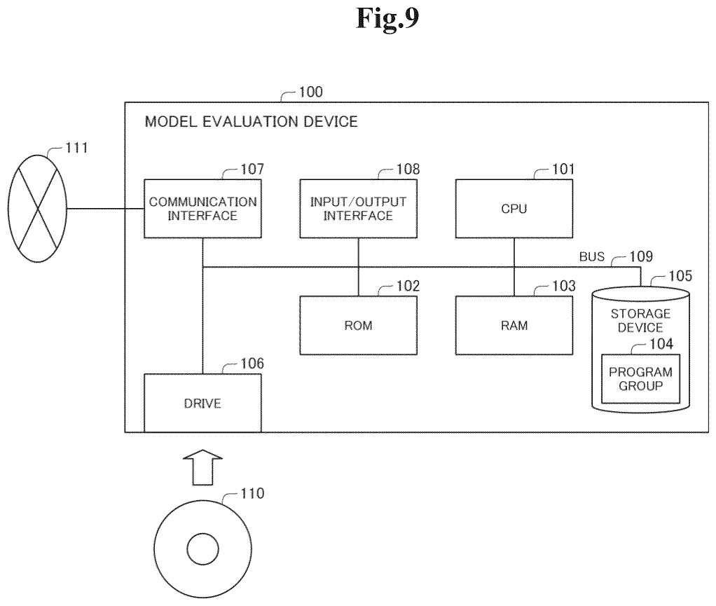

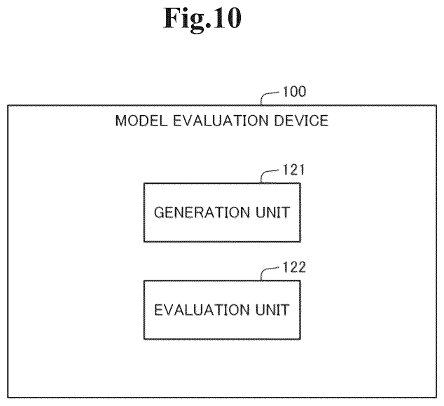

Next, a second example embodiment of the present disclosure will be described with reference to FIGS. 9 and 10. FIGS. 9 and 10 are block diagrams illustrating a configuration of a model evaluation device according to the second example embodiment. Note that the present embodiment shows the outline of a configuration of the model evaluation device in the embodiment described above.

First, a hardware configuration of a model evaluation device 100 in the present embodiment will be described with reference to FIG. 9. The model evaluation device 100 is configured of a typical information processing device having a hardware configuration as described below as an example.
Central Processing Unit (CPU) 101 (arithmetic device)
Read Only Memory (ROM) 102 (storage device)
Random Access Memory (RAM) 103 (storage device)
Program group 104 to be loaded to the RAM 103
Storage device 105 storing therein the program group 104
Drive 106 that performs reading and writing on a storage medium 110 outside the information processing device
Communication interface 107 connecting to a communication network 111 outside the information processing device
Input/output interface 108 for performing input/output of data
Bus 109 connecting the respective constituent elements

Note that FIG. 9 illustrates an example of a hardware configuration of an information processing device that is the model evaluation device 100. The hardware configuration of the information processing device is not limited to that described above. For example, the information processing device may be configured of part of the configuration described above, such as without the drive 106. Moreover, instead of the CPU, the information processing device may use a Graphic Processing Unit (GPU), a Digital Signal Processor (DSP), a Micro Processing Unit (MPU), a Floating Point number processing Unit (FPU), a Physics Processing Unit (PPU), a Tensor Processing Unit (TPU), a quantum processor, a microcontroller, or a combination thereof.

The model evaluation device 100 can construct, and can be equipped with, a generation unit 121 and an evaluation unit 122 illustrated in FIG. 10 through acquisition and execution of the program group 104 by the CPU 101. Note that the program group 104 is stored in the storage device 105 or the ROM 102 in advance, and is loaded to the RAM 103 and executed by the CPU 101 as needed. Further, the program group 104 may be provided to the CPU 101 via the communication network 111, or may be stored on the storage medium 110 in advance and read out by the drive 106 and supplied to the CPU 101. However, the generation unit 121 and the evaluation unit 122 may be constructed by dedicated electronic circuits for implementing such means.

The generation unit 121 generates a plurality of second machine learning models that are different from a first machine learning model subject to performance evaluation. Moreover, from the generated machine learning models, the generation unit 121 may further select the predetermined number of models on the basis of dissimilarity, based on a preset reference, of prediction labels output from the second machine learning models between the respective second machine learning models.

The evaluation unit 122 evaluates the first machine learning model on the basis of the prediction labels that are output by inputting the same data into the first machine learning model and to each of the second machine learning models.

Since the present disclosure is configured as described above, it is possible to generate a plurality of second machine learning models diversely, and by using the diverse second machine learning check models, evaluate the prediction performance of the first machine learning model. Therefore, it is possible to appropriately evaluate the first machine learning model promptly at a low cost.

Note that the program described above can be supplied to a computer by being stored in a non-transitory computer-readable medium of any type. Non-transitory computer-readable media include tangible storage media of various types. Examples of non-transitory computer-readable media include magnetic storage media (for example, flexible disk, magnetic tape, and hard disk drive), magneto-optical storage media (for example, magneto-optical disk), a CD-ROM (Read Only Memory), a CD-R, a CD-R/W, and semiconductor memories (for example, mask ROM, PROM (Programmable ROM), EPROM (Erasable PROM), flash ROM, and RAM (Random Access Memory)). The program may be supplied to a computer by a transitory computer-readable medium of any type. Examples of transitory computer-readable media include electric signals, optical signals, and electromagnetic waves. A transitory computer-readable medium can supply a program to a computer via a wired communication channel such as a wire and an optical fiber, or a wireless communication channel.

While the present disclosure has been described with reference to the example embodiments described above, the present disclosure is not limited to the above-described embodiments. The form and details of the present disclosure can be changed within the scope of the present disclosure in various manners that can be understood by those skilled in the art. Further, at least one of the functions of the generation unit 121 and the evaluation unit 122 described above may be carried out by an information processing device provided and connected to any location on the network, that is, may be carried out by so-called cloud computing.

### <Supplementary Notes>

The whole or part of the example embodiments disclosed above can be described as the following supplementary notes. Hereinafter, outlines of the configurations of a model evaluation device, a model evaluation method, and a program, according to the present disclosure, will be described. However, the present disclosure is not limited to the configurations described below.

### (Supplementary Note 1)

A model evaluation device comprising:
a generation unit that generates a plurality of second machine learning models that are different from a first machine learning model subject to performance evaluation; and
an evaluation unit that evaluates the first machine learning model on a basis of prediction labels, the prediction labels being output by inputting same data to the first machine learning model and to each of the second machine learning models.

### (Supplementary Note 2)

The model evaluation device according to supplementary note 1, further comprising
a selection unit that selects, from the generated second machine learning models, a predetermined number of the second machine learning models on a basis of dissimilarity, based on a preset reference, of the prediction labels output from the second machine learning models between the second machine learning models, wherein
the evaluation unit evaluates the first machine learning model on a basis of the prediction labels, the prediction labels being output by inputting the same data to the first machine learning model and to each of the selected second machine learning models.

### (Supplementary Note 3)

The model evaluation device according to supplementary note 2, wherein
the selection unit selects the second machine learning models in such a manner that the dissimilarity between the predetermined number of the second machine learning models becomes higher.

### (Supplementary Note 4)

The model evaluation device according to supplementary note 2, wherein
the selection unit extracts, from among the generated second machine learning models, two second machine learning models in which the dissimilarity between the second machine learning models is lower compared with other second machine learning models, and selects the second machine learning model by selecting either one of the extracted two second machine learning models.

### (Supplementary Note 5)

The model evaluation device according to supplementary note 4, wherein
the selection unit selects one of the extracted two second machine learning models, the one having a higher dissimilarity with another one of the generated second machine learning models.

### (Supplementary Note 6)

The model evaluation device according to supplementary note 2, wherein
the selection unit further selects, from the generated second machine learning models, the second machine learning model on a basis of a minimum spanning tree in a graph in which each of the generated second machine learning models is represented as a node and the dissimilarity between the second machine learning models is represented as a weight of a side linking the nodes.

### (Supplementary Note 7)

The model evaluation device according to supplementary note 1, wherein
the evaluation unit evaluates the first machine learning model on a basis of a matching degree between a correct label that is the prediction label output from each of the second machine learning models and the prediction label output from the first machine learning model.

### (Supplementary Note 8)

A model evaluation method comprising:
generating a plurality of second machine learning models that are different from a first machine learning model subject to performance evaluation; and
evaluating the first machine learning model on a basis of prediction labels, the prediction labels being output by inputting same data to the first machine learning model and to each of the second machine learning models.

### (Supplementary Note 9)

The model evaluation method according to supplementary note 8, further comprising:
from the generated second machine learning models, selecting a predetermined number of the second machine learning models on a basis of dissimilarity, based on a preset reference, of the prediction labels output from the second machine learning models between the second machine learning models; and
evaluating the first machine learning model on a basis of the prediction labels, the prediction labels being output by inputting the same data to the first machine learning model and to each of the selected second machine learning models.

### (Supplementary Note 10)

A computer-readable medium storing thereon a program for causing a computer to execute processing to:
generate a plurality of second machine learning models that are different from a first machine learning model subject to performance evaluation; and
evaluate the first machine learning model on a basis of prediction labels, the prediction labels being output by inputting same data to the first machine learning model and to each of the second machine learning models.

### REFERENCE SIGNS LIST

10 model evaluation device
11 check model generation unit
12 check model selection unit
13 performance evaluation unit
16 model storage unit
17 training data storage unit
18 estimation object data storage unit
100 model evaluation device
101 CPU
102 ROM
103 RAM
104 program group
105 storage device
106 drive
107 communication interface
108 input/output interface
109 bus
110 storage medium
111 communication network
121 generation unit
122 evaluation unit

What is claimed is:

1. A model evaluation device comprising:
at least one memory configured to store instructions; and
at least one processor configured to execute instructions to:
generate a plurality of second machine learning models that are different from a first machine learning model subject to performance evaluation; and
evaluate the first machine learning model on a basis of prediction labels, the prediction labels being output by inputting same data to the first machine learning model and to each of the second machine learning models.

2. The model evaluation device according to claim 1, wherein the at least one processor is configured to execute the instructions to:
from the generated second machine learning models, select a predetermined number of the second machine learning models on a basis of dissimilarity, based on a preset reference, of the prediction labels output from the second machine learning models between the second machine learning models; and
evaluate the first machine learning model on a basis of the prediction labels, the prediction labels being output by inputting the same data to the first machine learning model and to each of the selected second machine learning models.

3. The model evaluation device according to claim 2, wherein the at least one processor is configured to execute the instructions to
select the second machine learning models in such a manner that the dissimilarity between the predetermined number of the second machine learning models becomes higher.

4. The model evaluation device according to claim 2, wherein the at least one processor is configured to execute the instructions to,
from among the generated second machine learning models, extract two second machine learning models in which the dissimilarity between the second machine learning models is lower compared with other second machine learning models, and select the second machine learning model by selecting either one of the extracted two second machine learning models.

5. The model evaluation device according to claim 4, wherein the at least one processor is configured to execute the instructions to
select one of the extracted two second machine learning models, the one having a higher dissimilarity with another one of the generated second machine learning models.

6. The model evaluation device according to claim 2, wherein the at least one processor is configured to execute the instructions to,
from the generated second machine learning models, further select the second machine learning model on a basis of a minimum spanning tree in a graph in which each of the generated second machine learning models is represented as a node and the dissimilarity between the second machine learning models is represented as a weight of a side linking the nodes.

7. The model evaluation device according to claim 1, wherein the at least one processor is configured to execute the instructions to
evaluate the first machine learning model on a basis of a matching degree between a correct label that is the prediction label output from each of the second machine learning models and the prediction label output from the first machine learning model.

8. A model evaluation method comprising:
generating a plurality of second machine learning models that are different from a first machine learning model subject to performance evaluation; and
evaluating the first machine learning model on a basis of prediction labels, the prediction labels being output by inputting same data to the first machine learning model and to each of the second machine learning models.

9. The model evaluation method according to claim 8, further comprising:
from the generated second machine learning models, selecting a predetermined number of the second machine learning models on a basis of dissimilarity, based on a preset reference, of the prediction labels output from the second machine learning models between the second machine learning models; and
evaluating the first machine learning model on a basis of the prediction labels, the prediction labels being output by inputting the same data to the first machine learning model and to each of the selected second machine learning models.

10. A non-transitory computer-readable medium storing thereon a program comprising instructions for causing a computer to execute processing to:
generate a plurality of second machine learning models that are different from a first machine learning model subject to performance evaluation; and
evaluate the first machine learning model on a basis of prediction labels, the prediction labels being output by inputting same data to the first machine learning model and to each of the second machine learning models.

11. The model evaluation method according to claim 9, further comprising
selecting the second machine learning models in such a manner that the dissimilarity between the predetermined number of the second machine learning models becomes higher.

12. The model evaluation method according to claim 9, further comprising
from among the generated second machine learning models, extracting two second machine learning models in which the dissimilarity between the second machine learning models is lower compared with other second machine learning models, and selecting the second machine learning model by selecting either one of the extracted two second machine learning models.

13. The model evaluation method according to claim 12, further comprising
selecting one of the extracted two second machine learning models, the one having a higher dissimilarity with another one of the generated second machine learning models.

14. The model evaluation method according to claim 9, further comprising
from the generated second machine learning models, further selecting the second machine learning model on a basis of a minimum spanning tree in a graph in which each of the generated second machine learning models is represented as a node and the dissimilarity between the second machine learning models is represented as a weight of a side linking the nodes.

15. The model evaluation method according to claim 8, further comprising
evaluating the first machine learning model on a basis of a matching degree between a correct label that is the prediction label output from each of the second machine learning models and the prediction label output from the first machine learning model.
